(19) United States
(12) Patent Application Publication
(10) Pub. No.: US 2014/0006826 A1
(43) Pub. Date: Jan. 2, 2014

(54) LOW POWER LOW FREQUENCY SQUELCH BREAK PROTOCOL

(71) Applicant: Mahesh Wagh, Portland, OR (US)

(72) Inventor: Mahesh Wagh, Portland, OR (US)

(21) Appl. No.: 13/539,359

(22) Filed: Jun. 30, 2012

(51) Int. Cl. G06F 1/32

(52) U.S. Cl. 713/323

(57) ABSTRACT

Methods and apparatus for provision of a low power, low frequency squelch break protocol are described. In some embodiments, a fixed or variable time transmitter LFPS (Low Frequency Periodic Signaling) mechanism may be used that does not require a handshake and therefore much simpler in implementation than USB3 (Universal Serial Bus 3.0), for example. Also, an embodiment does not require a link common mode to be established and therefore may be optimized to support shorter durations for effecting exit from an electrical idle state that may be established via power-gating, for example. Other embodiments are also disclosed.

### FIELD

The present disclosure generally relates to the field of electronics. More particularly, an embodiment of the invention relates to techniques for provision of a low power, low frequency squelch break protocol.

### BACKGROUND

One common interface used in computer systems is Peripheral Component Interconnect Express (PCIe). PCIe specification defines several Active State Power Management (ASPM) mechanism such as L0s, L1, and L2/L3 to allow PCIe controllers to save power when the link is in idle or when the platform is in idle. When a PCIe controller enters ASPM L1 state, power gating may be triggered to reduce leakage power. However, the circuitry may be completely power gated which may impede resumption of other link operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-2 and 5-6 illustrate block diagrams of embodiments of computing systems, which may be utilized to implement various embodiments discussed herein.

FIGS. 3 and 4 illustrate signal diagrams, according to some embodiments.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

As process technology improves in dimensions, the influence of leakage power on the total power dissipated in the platform grows. While dynamic power may be reduced significantly by controlling the activity factor (e.g., through clock gating), leakage power may generally only be reduced significantly when the entire power grid is turned off (e.g., through power gating). This indicates the significance of power gating features on PCIe controllers, PCIe end points, PCIe switches, and/or PCIe root port. More specifically, there are new low power link states defined for PCIe that permit the PCIe physical layer to be completely power gated. Since the physical layer is completely power gated, a mechanism is required to indicate break from electrical idle state to wake the physical layer to resume link operations.

Two mechanisms may be considered for exiting an electrical idle state, e.g., an out-of-band mechanism and/or an in-band mechanism. Either of these mechanisms may use low power, low frequency electrical signaling to indicate electrical idle state. The electrical signaling scheme may be based on the LFPS (Low Frequency Periodic Signaling) scheme defined by USB3 (Universal Serial Bus 3.0) specification which may improve signal initialization, low power management, and/or boast other power management features. A higher level protocol may be used to indicate electrical idle state to break squelch and then resume link traffic. In addition to LFPS, USB3 also defines a handshake mechanism which may be utilized.

In some embodiments, a fixed or variable time transmitter LFPS mechanism may be used that does not require a handshake and therefore much simpler in implementation than USB3, for example. Also, an embodiment does not require a link common mode to be established and therefore may be optimized to support shorter durations for effecting exit from an electrical idle state that may be established via power-gating, for example, indicating exit without electrical signaling that establishes common mode. In some embodiments, link common mode may be achieved separately, e.g., when the high speed circuits are turned on or the squelch break circuits are turned on.

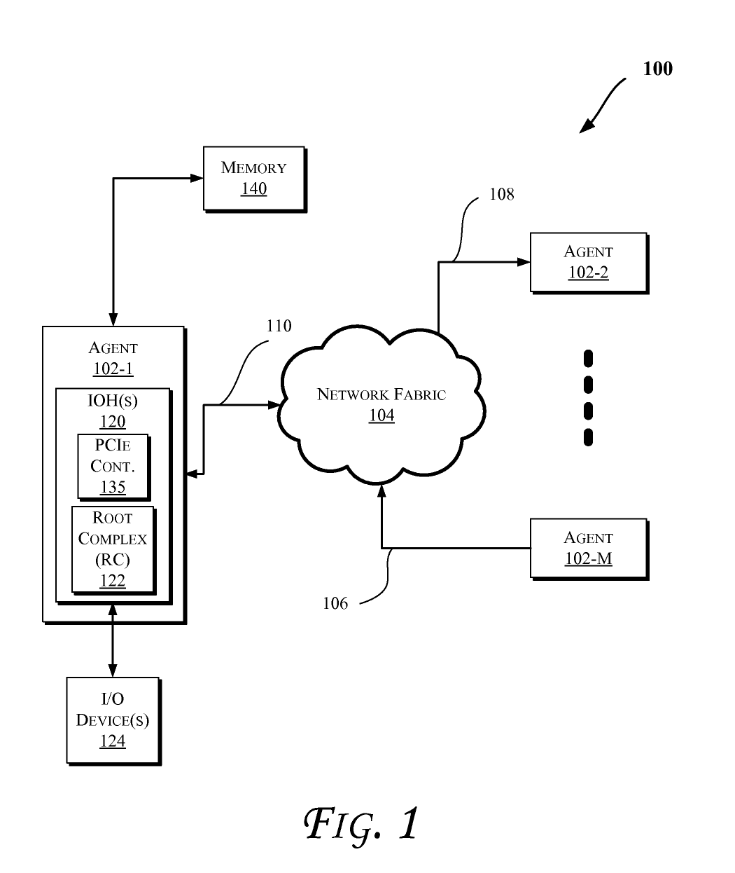

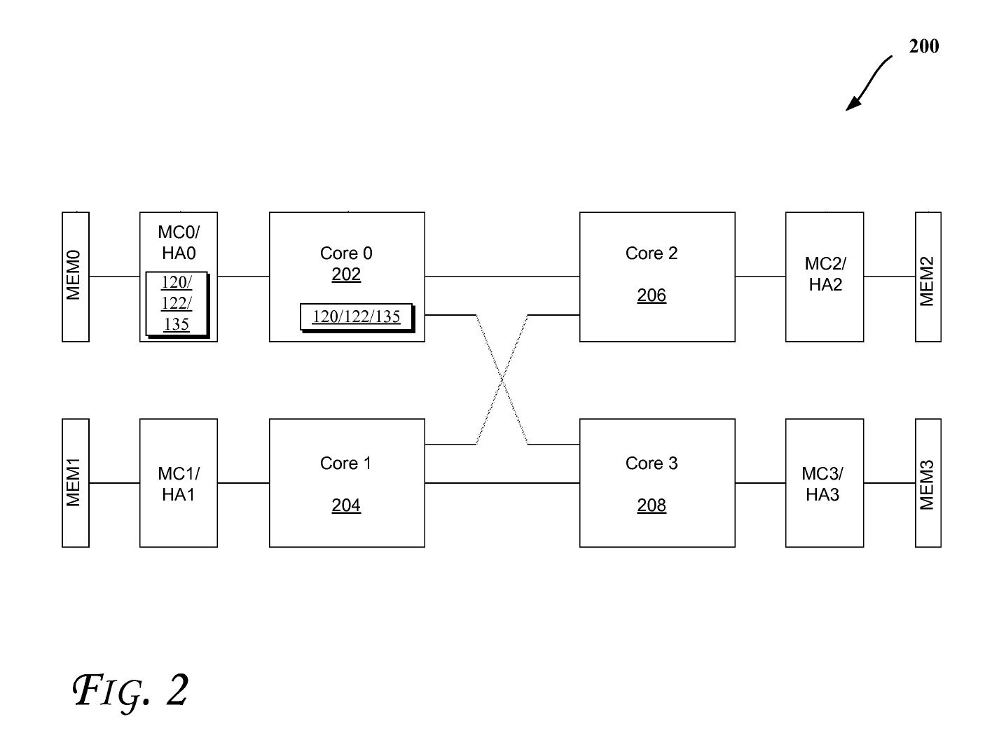

Various embodiments are discussed herein with reference to a computing system component, such as the components discussed herein, e.g., with reference to FIGS. 1-2 and 5-6. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, the agents 102 may be components of a computing system, such as the computing systems discussed with reference to FIGS. 2 and 5-6.

As illustrated in FIG. 1, the agents 102 may communicate via a network fabric 104. In an embodiment, the network fabric 104 may include one or more interconnects (or interconnection networks) that communicate via a serial (e.g., point-to-point) link and/or a shared communication network. For example, some embodiments may facilitate component debug or validation on links that allow communication with fully buffered dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

Also, in accordance with an embodiment, one or more of the agents 102 may include one or more Input/Output Hubs (IOHs) 120 to facilitate communication between an agent (e.g., agent 102-1 shown) and one or more Input/Output (“I/O” or “IO”) devices 124 (such as PCIe I/O devices). The IOH 120 may include a Root Complex (RC) 122 (that includes one or more root ports) to couple and/or facilitate communication between components of the agent 102-1 (such as a processor, memory subsystem, etc.) and the I/O devices 124 in accordance with PCIe specification (e.g., in accordance with PCI Express Base Specification 3.0, Revision 3.0, version 1.0 Nov. 10, 2010 and Errata for the PCI Express Base Specification Revision 3.0, Oct. 20, 2011). In some embodiments, one or more components of a multi-agent system (such as processor core, chipset, input/output hub, memory controller, etc.) may include the RC 122 and/or IOHs 120, as will be further discussed with reference to the remaining figures.

Additionally, the agent 102 may include a PCIe controller 135 to manage various operations of a PCIe interface including for example power management features/aspects of PCIe components in the agent 102. Further, as illustrated in FIG. 1, the agent 102-1 may have access to a memory 140. As will be further discussed with reference to FIGS. 2-6, the memory 140 may store various items including for example an OS, a device driver, etc.

More specifically, FIG. 2 is a block diagram of a computing system 200 in accordance with an embodiment. System 200 may include a plurality of sockets 202-208 (four shown but some embodiments may have more or less socket). Each socket may include a processor and one or more of IOH 120, RC 122, and PCIe Controller 135. In some embodiments, IOH 120, RC 122, and/or PCIe Controller 135 may be present in one or more components of system 200 (such as those shown in FIG. 2). Further, more or less 120, 122, and/or 135 blocks may be present in a system depending on the implementation.

Additionally, each socket may be coupled to the other sockets via a point-to-point (PtP) link, such as a Quick Path Interconnect (QPI). As discussed with respect the network fabric 104 of FIG. 1, each socket may be coupled to a local portion of system memory, e.g., formed by a plurality of Dual Inline Memory Modules (DIMMs) that may include dynamic random access memory (DRAM).

As shown in FIG. 2, each socket may be coupled to a Memory Controller (MC)/Home Agent (HA) (such as MC0/HA0 through MC3/HA3). The memory controllers may be coupled to a corresponding local memory (labeled as MEM0 through MEM3), which may be a portion of system memory (such as memory 412 of FIG. 4). In some embodiments, the memory controller (MC)/Home Agent (HA) (such as MC0/HA0 through MC3/HA3) may be the same or similar to agent 102-1 of FIG. 1 and the memory, labeled as MEM0 through MEM3, may be the same or similar to memory devices discussed with reference to any of the figures herein. Generally, processing/caching agents may send requests to a home node for access to a memory address with which a corresponding “home agent” is associated. Also, in one embodiment, MEM0 through MEM3 may be configured to mirror data, e.g., as master and slave. Also, one or more components of system 200 may be included on the same integrated circuit die in some embodiments.

Furthermore, one implementation (such as shown in FIG. 2) may be for a socket glueless configuration with mirroring. For example, data assigned to a memory controller (such as MC0/HA0) may be mirrored to another memory controller (such as MC3/HA3) over the PtP links.

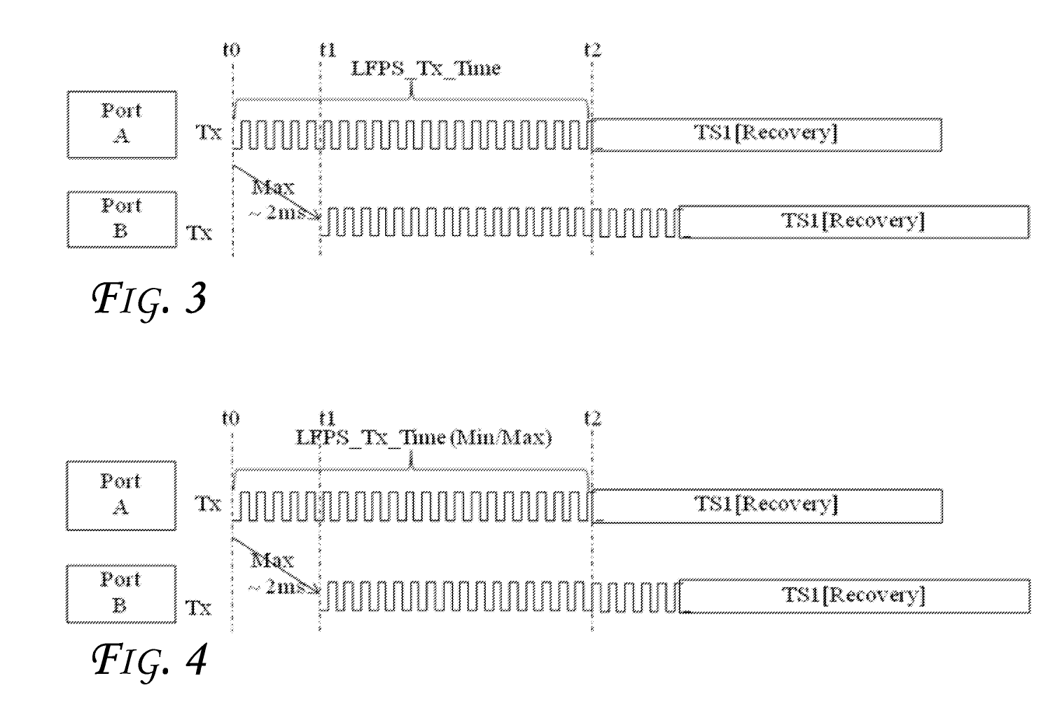

FIG. 3 illustrates a signal diagram associated with a fixed LFPS transmit time, according to an embodiment. In an embodiment, one or more components of the systems of FIG. 1, 2, 5, or 6 (such as the IOH 120, RC 122, and/or the PCIe Controller 135) may be used to detect, communicate, or generate the signal shown in FIG. 3. For example, ports A and B may refer to ports across a (e.g., point-to-point) link, for example, one being a downstream port and the other being an upstream port.

As illustrated in FIG. 3, port A may initiate exit from electrical idle state (to reach recovery (TS1)) using the LFPS mechanisms. In one embodiment, Rx (Receive) Max Detect Time refers to the time it takes for some Rx logic (e.g., a receiver side of the link) to detect LFPS, e.g., with 100 ns as a maximum value. This means that LFPS Tx (Transmit) duration time needs to be greater than this value. Hence, “t0-t1” is the time from receipt of LFPS to transmission of LFPS, e.g., with maximum of about 2 ms and minimum of about 300 ns in some embodiments. “t0-t2” is the total LFPS transmission time (LFPS_Tx_Time), e.g., about 600 ns. LFPS to TS (Training Sequences) transition time (e.g., about 20 ns) refers to the need for allowance of the time when the Tx logic transitions from transmitting LFPS to data patterns (such as training sequences). There may be a LFPS timeout period when transitioning from L1 to L1.1 and L1.2, i.e. time to power-gate. This may avoid a race condition when one end of the link is transitioning its high speed lanes to off (including those coupled to a high speed squelch detector) and the other end immediately starts exiting using LFPS and training sequences. There is a chance that LFPS sequences collide with the high power circuits being turned off and the training sequences to collide with the LFPS detector.

Accordingly, a fixed number of LFPS may be present before transitioning to transmitting Training Requests. Also, the high speed Tx logic may be ready to drive training sequences. In an embodiment, the high speed Tx logic needs to be ready to drive training sequences. Also, capability to duty cycle LFPS receiver may be limited in one embodiment.

FIG. 4 illustrates a signal diagram of a variable (e.g., minimum/maximum) LFPS transmit time, according to an embodiment. In an embodiment, In an embodiment, one or more components of the systems of FIG. 1, 2, 5, or 6 (such as the IOH 120, RC 122, and/or the PCIe Controller 135) may be used to detect, communicate, or generate the signal shown in FIG. 4. For example, ports A and B may refer to ports across a (e.g., point-to-point) link, for example, one being a downstream port and the other being an upstream port.

As illustrated in FIG. 4, port A may initiate exit from electrical idle state (to reach recovery (TS1)) using LFPS mechanisms. In one embodiment, Rx (Receive) Max Detect Time refers to the time it takes for Rx logic (e.g., a receiver side of the link) to detect LFPS, e.g., with 100 ns as a maximum value. This means that LFPS Tx (Transmit) duration time needs to be greater than this value. Hence, “t0-t1” is the time (minimum/maximum) from receipt of LFPS to transmission of LFPS, e.g., with maximum of about 2 ms and minimum of about 300 ns. “t0-t2” is the total (minimum/maximum) LFPS transmission time (LFPS_Tx_Time). Minimum LFPS Tx Time may be as the time defined in FIG. 3 (e.g., about 600 ns) but there may also be a maximum LFPS_Tx_Time of 2 ms in an embodiment. This permits the Tx high speed logic to be within the minimum to maximum range. This provides design flexibility and implementations may be optimized to operate as discussed with reference to FIG. 3, for example.

Accordingly, the minimum/maximum time may provide design flexibility. Also, capability to duty cycle LFPS receiver may be limited in one embodiment. Further, the corner case (race condition as described above) may need to be handled as discussed with reference to FIG. 3.

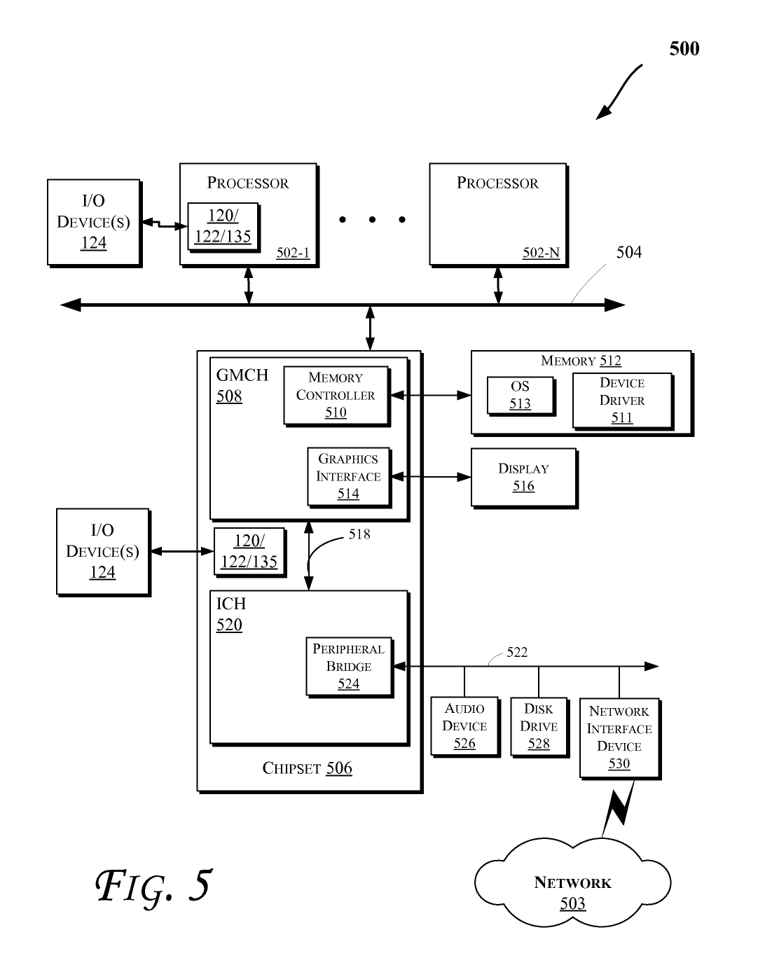

FIG. 5 illustrates a block diagram of a computing system 500 in accordance with an embodiment of the invention. The computing system 500 may include one or more central processing unit(s) (CPUs) 502-1 through 502-N or processors (collectively referred to herein as “processors 502” or more generally “processor 502”) that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors.

Also, the operations discussed with reference to FIGS. 1-4 may be performed by one or more components of the system 500. In some embodiments, the processors 502 may be the same or similar to the processors 202-208 of FIG. 2. Furthermore, the processors 502 (or other components of the system 500) may include one or more of the IOH 120, RC 122, and the PCIe Controller 135. Moreover, even though FIG. 5 illustrates some locations for items 120/122/135, these components may be located elsewhere in system 500. For example, I/O device(s) 124 may communicate via bus 522, etc.

A chipset 506 may also communicate with the interconnection network 504. The chipset 506 may include a graphics and memory controller hub (GMCH) 508. The GMCH 508 may include a memory controller 510 that communicates with a memory 512. The memory 512 may store data, including sequences of instructions that are executed by the CPU 502, or any other device included in the computing system 500. For example, the memory 512 may store data corresponding to an operation system (OS) 513 and/or a device driver 511 as discussed with reference to the previous figures. In an embodiment, the memory 512 and memory 140 of FIG. 1 may be the same or similar. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

Additionally, one or more of the processors 502 may have access to one or more caches (which may include private and/or shared caches in various embodiments) and associated cache controllers (not shown). The cache(s) may adhere to one or more cache coherent protocols. The cache(s) may store data (e.g., including instructions) that are utilized by one or more components of the system 500. For example, the cache may locally cache data stored in a memory 512 for faster access by the components of the processors 502. In an embodiment, the cache (that may be shared) may include a mid-level cache and/or a last level cache (LLC). Also, each processor 502 may include a level 1 (L1) cache. Various components of the processors 502 may communicate with the cache directly, through a bus or interconnection network, and/or a memory controller or hub.

The GMCH 508 may also include a graphics interface 514 that communicates with a display device 516, e.g., via a graphics accelerator. In one embodiment of the invention, the graphics interface 514 may communicate with the graphics accelerator via an accelerated graphics port (AGP). In an embodiment of the invention, the display 516 (such as a flat panel display) may communicate with the graphics interface 514 through, for example, a signal converter that translates a digital representation of an image stored in a storage device such as video memory or system memory into display signals that are interpreted and displayed by the display 516. The display signals produced by the display device may pass through various control devices before being interpreted by and subsequently displayed on the display 516.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. Also, various components (such as the network interface device 530) may communicate with the GMCH 508 in some embodiments of the invention. In addition, the processor 502 and one or more components of the GMCH 508 and/or chipset 506 may be combined to form a single integrated circuit chip (or be otherwise present on the same integrated circuit die).

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

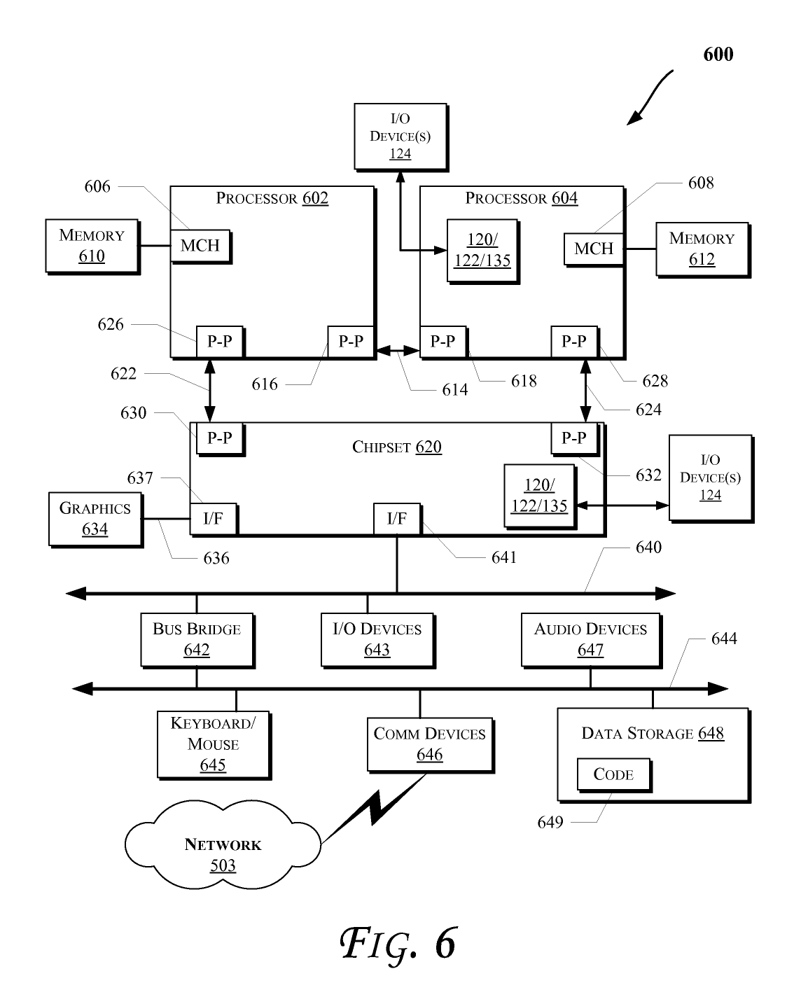

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5. As shown in FIG. 6, the processors 602 and 604 may also include the cache(s) discussed with reference to FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a high-performance graphics circuit 634 via a high-performance graphics interface 636, e.g., using a PtP interface circuit 637.

At least one embodiment of the invention may be provided within the processors 602 and 604 or chipset 620. For example, the processors 602 and 604 and/or chipset 620 may include one or more of the IOH 120, RC 122, and the PCIe Controller 135. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6. Hence, location of items 120/122/135 shown in FIG. 6 is exemplary and these components may or may not be provided in the illustrated locations.

The chipset 620 may communicate with a bus 640 using a PtP interface circuit 641. The bus 640 may have one or more devices that communicate with it, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6. Additionally, such computer-readable media may be downloaded as a computer program product, wherein the program may be transferred from a remote computer (e.g., a server) to a requesting computer (e.g., a client) by way of data signals transmitted via a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a first agent coupled to a second agent via a link; and
the first agent having controller logic to cause the link to exit from an electrical idle state in response to a Low Frequency Periodic Signaling (LFPS) signal,
wherein a transmit duration time of the LFPS signal is to be greater than a time it takes a receiver logic of the second agent to detect the LFPS signal.

2. The apparatus of claim 1, wherein the controller logic is to cause the link to exit from the electrical idle state without performing a handshake.

3. The apparatus of claim 1, wherein the controller logic is to cause the link to exit from the electrical idle state without establishment of a link common mode.

4. The apparatus of claim 1, wherein the controller logic is to wait for a timeout period when transitioning between two power states to reduce or avoid a race condition between LFPS signals and high power circuits being turned off on opposite ends of the link.

5. The apparatus of claim 1, wherein the first agent is to comprise a root complex to facilitate communication between the first agent and the second agent over the link.

6. The apparatus of claim 1, wherein the first agent is to comprise one or more of: a processor core, a chipset, an input/output hub, or a memory controller.

7. The apparatus of claim 1, wherein the second agent is to comprise an input/output device.

8. The apparatus of claim 1, wherein the link is to comprise a point-to-point coherent interconnect.

9. The apparatus of claim 1, wherein the first agent is to comprise a plurality of processor cores and one or more sockets.

10. The apparatus of claim 1, wherein one or more of the first agent, the second agent, and the memory are on a same integrated circuit chip.

11. The apparatus of claim 1, wherein the link comprises a Peripheral Component Interconnect Express (PCIe) link.

12. The apparatus of claim 1, wherein the transmit duration time is to be between a minimum value and a maximum value.

13. The apparatus of claim 2, wherein the minimum value is about 600 ns and the maximum value is about 2 ms.

14. The apparatus of claim 1, wherein the transmit duration time is about 600 ns.

15. A method comprising:
receiving a Low Frequency Periodic Signaling (LFPS) signal over a link that couples a first agent to a second agent; and
causing the link to exit from an electrical idle state in response to the LFPS signal at a controller logic of the first agent,
wherein a transmit duration time of the LFPS signal is to be greater than a time it takes a receiver logic of the second agent to detect the LFPS signal.

16. The method of claim 15, further comprising the controller logic causing the link to exit from the electrical idle state without performing a handshake.

17. The method of claim 15, further comprising the controller logic causing the link to exit from the electrical idle state without establishment of a link common mode.

18. The method of claim 15, further comprising waiting for a timeout period when transitioning between two power states to reduce or avoid a race condition between LFPS signals and high power circuits being turned off on opposite ends of the link.

19. The method of claim 15, wherein the link comprises a Peripheral Component Interconnect Express (PCIe) link.

20. The method of claim 15, wherein the transmit duration time is between a minimum value and a maximum value.

21. A computing system comprising:
an input/output hub to couple a processor core and an input/output device via a link; and
the input/output hub having controller logic to cause the link to exit from an electrical idle state in response to a Low Frequency Periodic Signaling (LFPS) signal,
wherein a transmit duration time of the LFPS signal is to be greater than a time it takes a receiver logic to detect the LFPS signal.

22. The system of claim 21, wherein the controller logic is to cause the link to exit from the electrical idle state without performing a handshake.

23. The system of claim 21, wherein the controller logic is to cause the link to exit from the electrical idle state without establishment of a link common mode.

24. The system of claim 21, wherein the controller logic is to wait for a timeout period when transitioning between two power states to reduce or avoid a race condition between LFPS signals and high power circuits being turned off on opposite ends of the link.

25. The system of claim 21, wherein the input/output hub is to comprise a root complex to facilitate communication between the input/output device and the processor core over the link.

26. The system of claim 21, wherein the link is to comprise a point-to-point coherent interconnect.

27. The system of claim 21, wherein one or more of the processor core, the input/output hub, and a memory are on a same integrated circuit chip.

28. The system of claim 21, wherein the link comprises a Peripheral Component Interconnect Express (PCIe) link.

29. The system of claim 21, wherein the transmit duration time is to be between a minimum value and a maximum value.

30. The system of claim 21, wherein the transmit duration time is about 600 ns.
